(19) United States
(12) Patent Application Publication
(10) Pub. No.: US 2021/0197615 A1
(43) Pub. Date: Jul. 1, 2021

(54) Moving apparatus based on bearing points created by end of lever arms with changeable length

(71) Applicant: Minh Tam Do, Ho Chi Minh (VN)

(72) Inventor: Minh Tam Do, Ho Chi Minh (VN)

(21) Appl. No.: 17/198,343

(22) Filed: Mar. 11, 2021

Related U.S. Application Data
(62) Division of application No. 15/564,733, filed on Oct. 5, 2017.

(51) Int. Cl. B60B 9/28; B62D 57/024; A61G 5/06; B62D 57/02; B60K 7/00; B62D 55/26

(52) U.S. Cl. CPC B60B 9/28; B62D 57/024; A61G 5/061; A61G 5/068; A61H 3/00; B60K 7/00; B62D 55/26; A61G 2203/70; B62D 57/02

(57) ABSTRACT

The present invention relates to moving apparatus based on bearing points created by ends of lever arms with changeable length. The lever arm comprises two main components: body and end of lever arm. Lever arm body moves spirally or pendulously around the axis which is different from its axis, end of lever arm moves in and out along the lever arm body. The combination of movement of body and end of the lever arm creates bearing points of the apparatus on the terrain, thus creating capability to overcome barricades of the apparatus. Moreover, the combination of these two movements, when following appropriate principles, creates equilibrium for the frame of the apparatus on various terrains.

### FIELD OF THE INVENTION

The present invention relates to components and apparatus, whose functions are similar to wheels, chain wheels, walking apparatuses (bearing-point apparatus for short) on moving vehicles, more specifically it relates to moving apparatus based on bearing points created by ends of lever arms with changeable length.

### BACKGROUND ART

Many moving apparatuses used in first-aid instruments or supporting equipment have been known. Currently, most of the bearing-point apparatuses are under the forms of wheels, chain wheels, pitches, etc. The apparatus of wheels has simple structure but low capability of overcoming barricades. The apparatus of chain wheels has good capability of overcoming barricades but they are bulky and inflexible. The walking apparatus, which imitates legs of humans and animals, has good capability of overcoming barricades but they are complicated, difficult to manufacture; moreover, rotating joints of waking apparatus need large operation space, resulting in walking apparatus being unable to smoothly operate in small areas (such as stairs).

### SUMMARY OF THE INVENTION

The present invention aims at surmounting the above mentioned shortcomings of the known apparatuses, and the primary objective of the present invention is to propose a moving apparatus based on bearing points created by ends of lever arms with changeable length, which is simpler in manufacturing and operation, achieving better criteria in overcoming barricades for moving vehicles such as first-aid instruments, providing supports in unfavorable terrains and environments . . . or simply it can be used as a walking assist device for the elderly and the disabled . . . Besides, other objects and advantages of the present invention can be found below.

With the objects mentioned above and other objects, the present invention relates to a moving apparatus based on bearing points created by end of lever arms with changeable length. The lever arm comprises two main components: body and end of lever arm. The lever arm changes its length by in-out movement of end of lever arm. In order for the apparatus to move, lever arm body moves spirally or pendulously around the axis which is different from its axis, end of lever arm moves in and out along the lever arm body. The combination of movement of body and end of the lever arm creates bearing points of the apparatus on the terrain, thus creating capability to overcome barricades of the apparatus. Thanks to ends of lever arm working as bearing points, the capability of overcoming barricades of the apparatus is better than the apparatuses of wheels and chain wheels. Moreover, because end of lever arm moves along the body, it requires smaller operation space than that of rotating joints in walking apparatus, thus operates better in small area. Additionally, the combination of these two movements, when following appropriate principles, creates equilibrium for the frame of the apparatus on various terrains.

In one aspect, the present invention proposes a moving apparatus comprising lever arms, wherein each lever arm comprises body and end of lever arm, the lever arm can change its length via in-out movement of the end of lever arm along the body to touch the terrain.

In an embodiment, the moving apparatus according to the above aspect, wherein lever arms are equipped on rotary tables to create wheel-type moving apparatus which can move based on the combination of rotational movement and changes in length of lever arms.

In an embodiment, the moving apparatus according to the first aspect, wherein lever arms are equipped proportionally to chain links to create chain wheel moving apparatus which can move based on the combination of rotational movement and changes in length of lever arms.

In an embodiment, the moving apparatus according to the first aspect, wherein:
lever arms are installed as clusters, wherein lever arms of each clusters are arranged equidistantly along the frame and can move on a separate plane in order that clusters of lever arms do not collide, and lever arm body can move pendulously around an axis on the apparatus frame which is different from that of the lever arm body;

lever arms in each cluster oscillates simultaneously thanks to the actuation in order to create moving apparatus under the form of pendulum oscillation which can move based on combination of pendulum oscillation of lever arm clusters and changes in length of each lever arm, which creates bearing points of the apparatus on the terrain.

In an embodiment, lever arms of each cluster oscillates simultaneously thanks to the structure of con rod-crankshaft, wherein one end of the crankshaft rotates around an axis on the apparatus frame and another end connects with con rods which connects with bodies of the lever arms by the remaining end in order that con rods push lever arms of each cluster to oscillates pendulously.

In an embodiment, lever arms of each cluster oscillates simultaneously thanks to the structure of con rod-camshaft, wherein the camshaft is installed rotatably to the apparatus frame and has exclusive groove with appropriate profile, the con rod has two ends connecting with lever arm bodies of a cluster and it is bolted to the groove in order that when the camshaft rotates, the groove pushes the bolt to move with the con rod to create pendulum oscillation of the cluster of lever arms.

In an embodiment, in-out movement along the body of the ends of lever arm to change lever arm length is created based on steam cylinder structure (or hydraulic cylinder structure), the lever arm lengthens when loading air (or oil) and vice versa.

In an embodiment, in-out movement along the body of the ends of lever arm to change lever arm length is created based on structure of rack wheel-rack bar, the lever arm lengthens when the rack wheel 10 rotates with proportionate direction and vice versa.

In an embodiment, in-out movement along the body of the ends of lever arm to change lever arm length is created based on worm shaft structure, the lever arm lengthens when the warm shaft rotates with proportionate direction and vice versa.

In an embodiment, in-out movement along the body of the ends of lever arm to change lever arm length is created based on combination of such controlling methods as spring, rack wheel and rack bar: the spring always pushes or pulls the lever arm to a direction, the rack wheel 10 pulls the lever arm in the opposite direction when it rotates.

### BRIEF DESCRIPTION OF DRAWINGS

FIG. 1 illustrates moving apparatus based on bearing points created by ends of lever arms in accordance with the first embodiment of the present invention;

FIG. 2 illustrates method of changing lever arm length based on steam cylinder structure (or hydraulic cylinder structure).

FIG. 3 illustrates method of changing lever arm length based on structure of rack wheel-rack bar;

FIG. 4 illustrates method of changing lever arm length based on worm shaft structure;

FIG. 5 illustrates method of changing lever arm length based on combination of such controlling methods as spring, rack wheel and rack bar;

FIG. 6 illustrates operation of the wheel apparatus when climbing stairs;

FIG. 7 illustrates another preferred embodiment of the moving apparatus based on bearing points created by ends of lever arms similar to the wheel apparatus (referred to as connecting-leg embodiment) according to the second embodiment of the present invention;

FIG. 8 illustrates operation of connecting-leg embodiment of the wheel apparatus when climbing stairs;

FIG. 9 illustrates structure of the moving apparatus based on lever arms similar to chain wheel apparatus according to the third embodiment of the present invention;

FIG. 10a is a front view showing a structure of the moving apparatus based on bearing points created by ends of lever arms similar to the walking apparatus (referred to as pendulum apparatus 1) according to a preferred embodiment of the present invention;

FIG. 10b is a side view showing a structure of the moving apparatus based on bearing points created by ends of lever arms similar to the walking apparatus (referred to as pendulum apparatus 1) illustrated in FIG. 10a;

FIGS. 11a and 11b illustrate method of creating pendulum oscillation of lever arms by the structure of con rod-crankshaft;

FIGS. 12a and 12b illustrate method of creating pendulum oscillation of lever arms by the structure of con rod-camshaft;

FIGS. 13a, 13b and 13c illustrate operating principle of the pendulum apparatus 1;

FIGS. 14a and 14b illustrate operation of pendulum apparatus 1 when climbing stairs;

FIG. 15a is a front view showing another preferred embodiment of the moving apparatus based on bearing points created by ends of lever arms similar to the walking apparatus (referred to as pendulum apparatus 2);

FIG. 15b is a side view showing another preferred embodiment of the moving apparatus based on bearing points created by ends of lever arms similar to the walking apparatus (referred to as pendulum apparatus 2);

FIGS. 16a, 16b and 16c illustrate operating principle of the pendulum apparatus 2;

FIGS. 17a and 17b illustrate operation of pendulum apparatus 2 when climbing stairs;

### DESCRIPTION OF THE PREFERRED EMBODIMENTS

The present invention will now be described based on preferred embodiments with reference to the accompanying drawings. These embodiments are merely exemplary in nature and are not intended to limit the present disclosure, application, or uses. The apparatus according to the present invention are illustrated in drawings with a schematic manner, i.e. the moving apparatus according to the present invention comprises frame and lever arms installed on the frame to create equilibrium in movement. In the drawings and in this description, lever aims are only schematically illustrated on one side of the frame, those who have average knowledge of corresponding technical areas can understand the layout on the remaining side in order that the apparatus can work.

As illustrated in FIG. 1, the moving apparatus based on bearing points created by ends of lever arms according to this embodiment is similar to the wheel apparatus. Lever arm comprises two main components: lever arm body 5 and end of lever arm 6. As illustrated in FIG. 1, lever arms are equidistantly equipped on rotary table 7. Rotary table 7 is installed on frame 8 of the apparatus. The apparatus can be controlled by a processor comprising proximity sensor, tilt sensor, accumulator, motor, air supply system, etc. Proximity sensor measures the distance between frame 8 and terrain 9. Tilt sensor measures the equilibrium of the frame 8. The controller operates and control operating mechanism based on predefined principles.

The rotary table 7 itself can rotate because of its engine (electrical engine, for example) and because of changes in length of lever arms. As illustrated in FIG. 1, when lever arm A lengthens, simultaneously lever arm C shortens, the rotary table will rotate towards the right side. The rotation movement because of change in lever arm length, which facilitates operation of the apparatus based on only two rotary tables, is similar to moving apparatuses on two wheels (such as Seaway) but it is easier to control and more stable when standing still. That is, two rotary tables on both sides of the frame will rotate because of change in length of lever arms. When standing still, multiple lever arms simultaneously touch the terrain to obtain equilibrium. The rotation movement of the rotary table is easily achieved simply by change in length of lever arms.

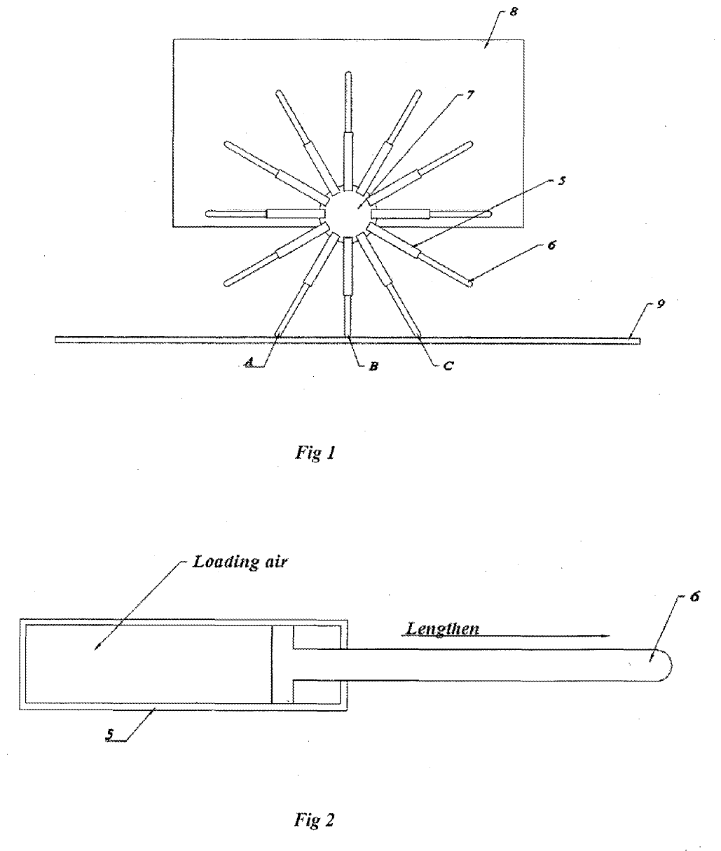

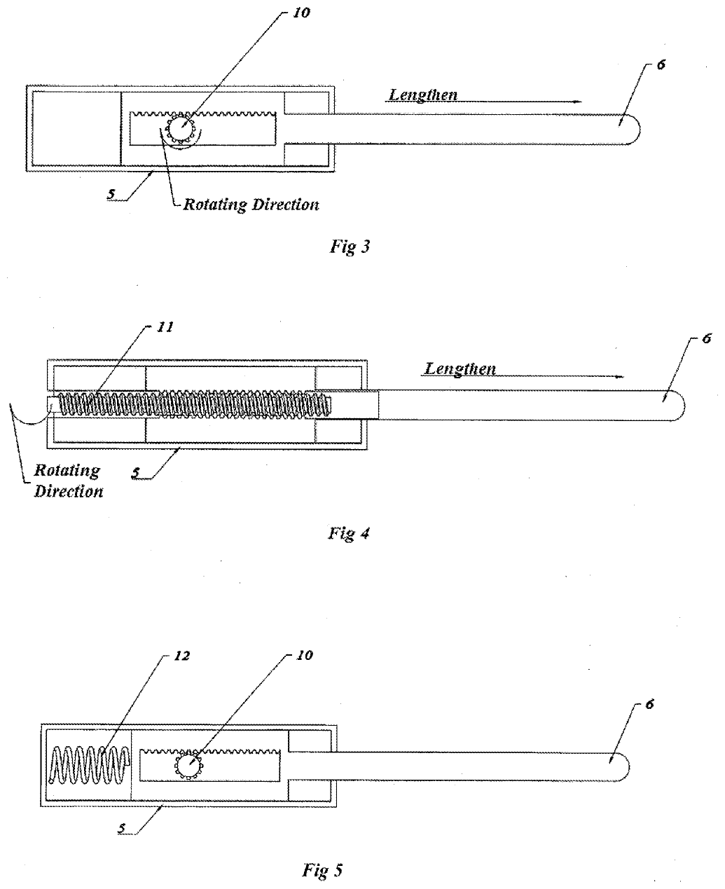

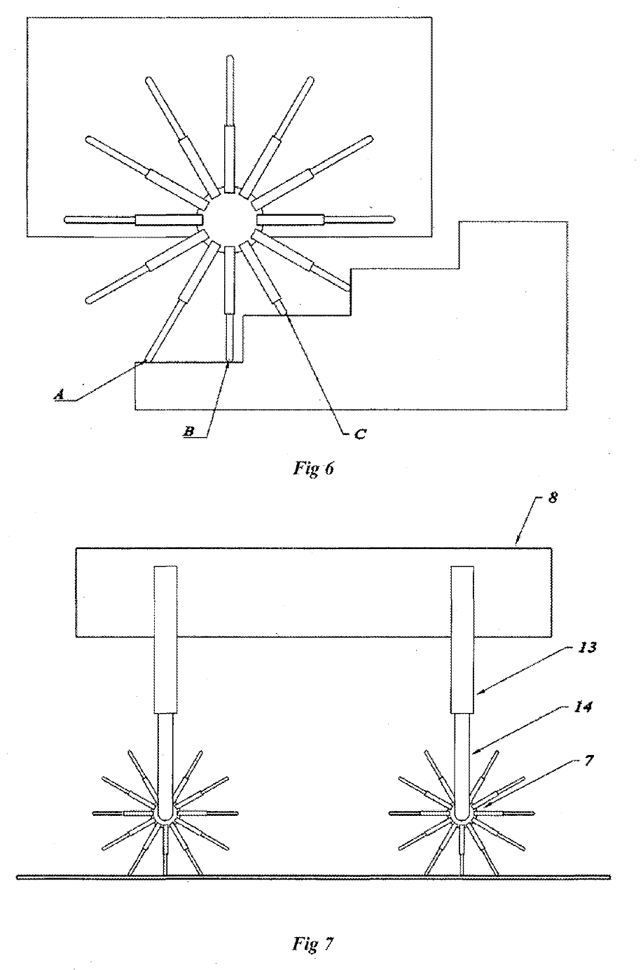

The movement along the body 5 of the end of lever arm 6 can be created based on steam cylinder structure (or hydraulic cylinder structure), when loading air (or oil) the lever arm lengthens and vice versa (see FIG. 2). According to another preferred embodiment, this operation can be based on structure of rack wheel-rack bar, the lever arm lengthens when rack wheel 10 rotates with proportionate direction and vice versa (see FIG. 3). Also, the control of lever arm length can be based on worm shaft structure, the lever arm lengthens when the worm shaft 11 rotates with proportionate direction and vice versa (see FIG. 4). Additionally, it is possible to combine multiple control methods such as spring, rack wheel and rack bar: spring 12 always pushes or pulls the lever arm to a direction, the rack wheel 10 pulls the lever arm in the opposite direction when it rotates (see FIG. 5).

In this structure, ends of lever arms A, B, C touch terrain 9. When it moves, length of lever arms is constantly adjusted based on predefined principles; e.g. according to principle on distance between frame and terrain: if this distance is higher than the predefined value, proximity sensor will influence the controller to shorten the ends of lever arms and vice versa; e.g. according to requirement on frame tilt level: if the frame tilts to a certain lever arm, tilt sensors will influence the controller to lengthen that lever arm or shorten the lever arm on the opposite direction in order to restore the equilibrium of the frame.

When rotary table 7 rotates, ends of lever arms will rotates in succession and reach the position of touching the terrain 9, i.e. positions of lever arms A, B, C and will be controlled by the aforementioned principle.

FIG. 6 illustrates operation of the moving apparatus based on bearing points created by ends of lever arms when climbing stairs, wherein lever arms in the positions of A, B, C can lean against the surface of stair step when changing their length. Based on these points, when rotary table 7 rotates, the frame will be proportionally lifted up, and simultaneously other lever arms will in succession fill in the positions of A, B, and C.

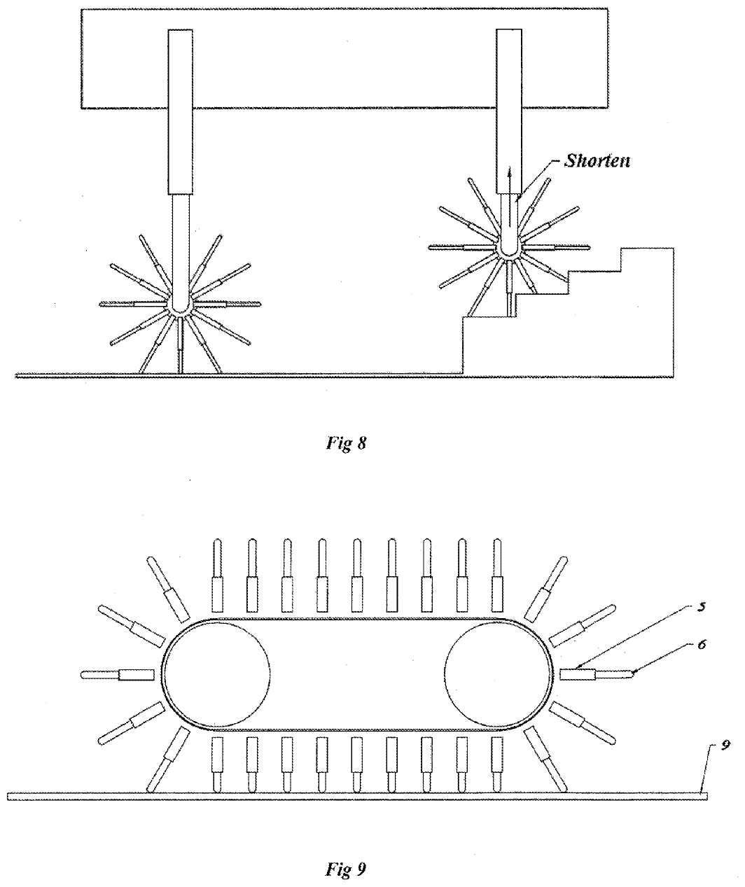

FIG. 7 illustrates another preferred embodiment of the moving apparatus based on bearing points created by ends of lever arms similar to wheel apparatus, wherein rotary table 7 is installed indirectly on frame 8 through the connecting-leg apparatus. The connecting-leg apparatus comprises 2 major parts: connecting-leg body 13 and connecting-leg end 14, which can move along the body to change its length or rotate relatively to the body to increase flexibility of the apparatus,

FIG. 8 illustrates operation of the apparatus according to this embodiment when climbing stairs, wherein the combination of length changes of the connecting leg and lever arms will make operation of the apparatus more flexible. The operation of lever arms are similar to the first embodiment mentioned above and the description will be skipped.

According to a preferred embodiment illustrated in FIG. 9, structure of the moving apparatus based on bearing points created by ends of lever arms is similar to chain wheel apparatus. As illustrated in FIG. 9, lever arms are installed proportionally to chain links. Operation mode and principle in this case is similar to those of wheel apparatus.

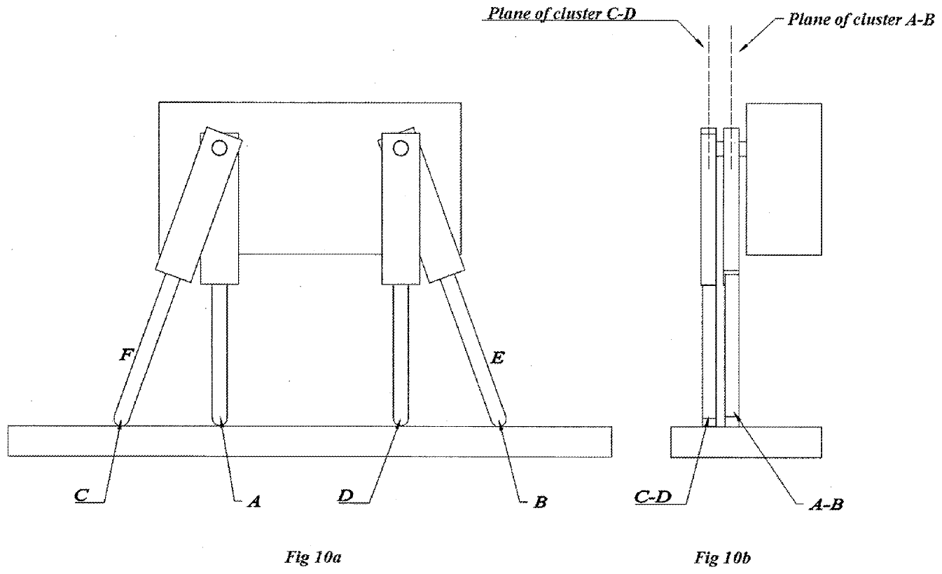

FIGS. 10a and 10b illustrate another structure of the moving apparatus based on bearing points created by ends of lever arms similar to the walking apparatus (referred to as pendulum apparatus 1). This moving apparatus comprises two separate clusters of lever arms. The first cluster comprises lever arms A and B, the second cluster comprises lever arms C and D. These lever arms can move pendulously around an axis which is different from that of the lever arm body and they are limited by two dead centers: front dead center E and back dead center F. Clusters of lever arms are installed on different sides in order that pendulum oscillation of lever arms does not collide. Specifically, cluster of lever arms A-B oscillates on the plane of cluster A-B, and cluster of lever arms C-D oscillates on the plane of cluster C-D. The operating principle of this apparatus will be described hereafter.

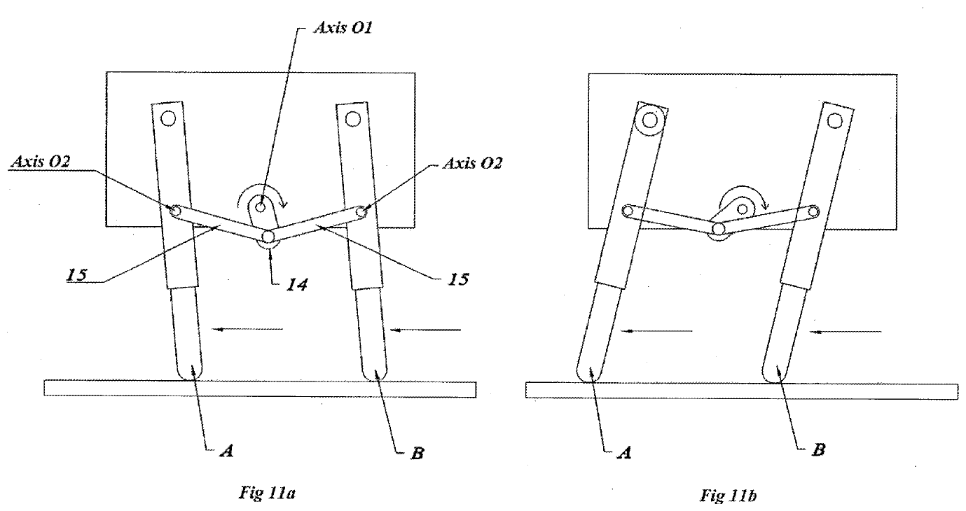

FIGS. 11a and 11b illustrate method of creating pendulum oscillation of a cluster of lever arms according to a preferred embodiment. This description is based on cluster of lever arms A-B with the movement created by the structure of con rod-crankshaft. The con rod-crankshaft cluster comprises crankshaft 14 rotating around axis O1 and con rod 15 connecting the remaining end of the crankshaft with axes O2 on lever arm bodies. When crankshaft 14 rotates around axis O1, con rod 15 will push lever arms of a cluster to move pendulously around its axis. In FIG. 11a, crankshaft 14 rotating with the arrow direction makes lever arms oscillate and move backwards. Similarly, oscillation of the cluster of lever arms C-D is created thanks to the con rod-crankshaft cluster.

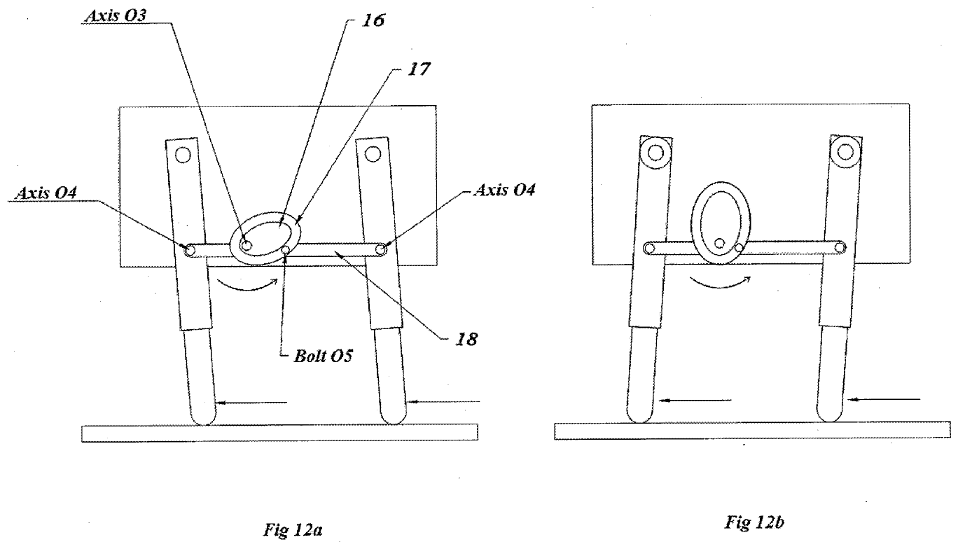

As illustrated in FIGS. 12a and 12b, another preferred embodiment to create movement of pendulum oscillation for the cluster of lever arms is structure of con rod-camshaft. In this embodiment, camshaft 16 has groove 17 with appropriate profile and rotates around axis O3, con rod 18 has two ends connecting with axis O4 on two lever arm bodies in a cluster. The con rod 18 is bolted by the bolt O5 in the groove 17. With such structure, when the camshaft 16 rotates, groove 17 will push bolt O5 to move with the con rod 18, creating movement of pendulum oscillation for the cluster of lever arms. With appropriate profile of the groove 17, the movement of pendulum oscillation will obtain better features than the structure of con rod-crankshaft.

Movement of pendulum oscillation for lever arms can also be created by such methods as steam cylinder structure (or hydraulic cylinder structure), or structure of rack wheel-rack bar, or worm shaft structure, etc. which is similar to structure creating movement along the lever arm body of the end of lever arm; wherein one end leans against the frame and the other end influences the lever arm body.

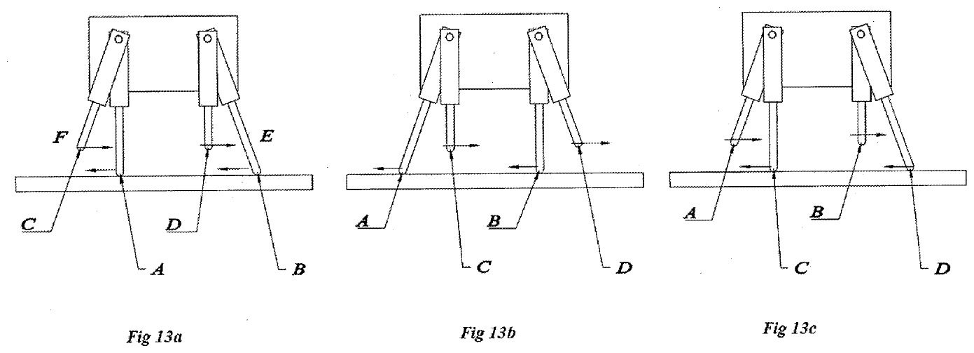

FIGS. 13a, 13b and 13c illustrate operating principle of the pendulum apparatus 1, wherein when lever arms A and B of the cluster A-B are lengthened and lean on terrain and move from front dead center E to back dead center F then lever arms C and D of the cluster C-D are shortened and move with no-load from back dead center F to front dead center E; at this point the apparatus moves based on two bearing points of lever arms A and B. When the cluster C-D reaches the front dead center then lever arms C and D will be lengthened to the terrain to become new bearing points for the movement, simultaneously lever arms A and B reach the back dead center and they are shortened, move with no-load to the front dead center; at this point two clusters exchange their roles and the apparatus moves based on two bearing points of the lever arms C and D. Such in-succession operation of the two clusters of lever arms creates movement of the apparatus. Meanwhile, longitudinal movement of each lever arms still complies with predefined principles as mentioned in wheel apparatus in order to maintain stability and equilibrium of the frame when moving. That is, in this moving apparatus, the movement is created based on combination between oscillation of clusters of lever arms and changes in lever arm length of the clusters. Thus, the object is kept in balance and can move under the form of a walking apparatus.

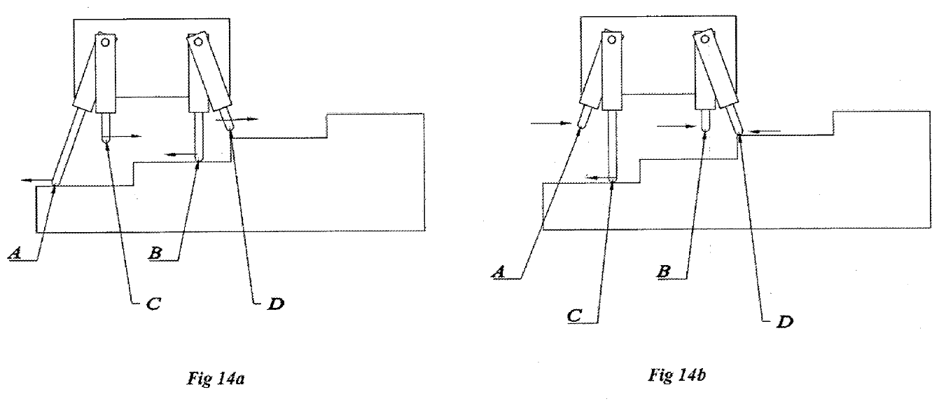

FIGS. 14a and 14b illustrate operation of pendulum apparatus 1 when climbing stairs. Length of lever arms is flexibly changed according, to terrain to create bearing points. Pendulum oscillation of clusters of lever arms is similar to moving on flat terrain.

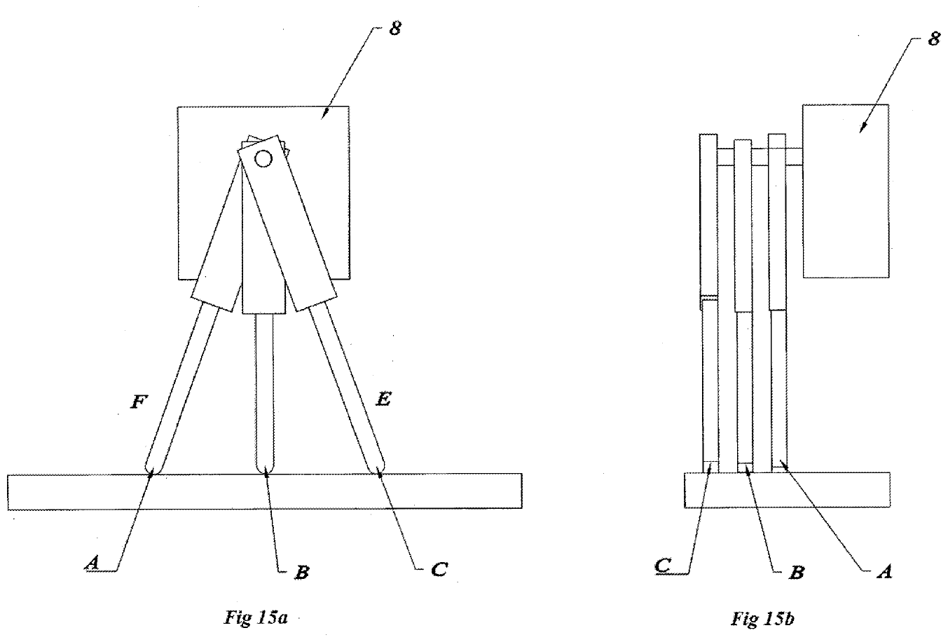

FIGS. 15a and 15b illustrate a preferred embodiment of the moving apparatus based on bearing points created by ends of lever arms which is similar to walking apparatus (referred to as pendulum apparatus 2). Wherein lever arms are installed in clusters of three lever arms A, B and C. These lever arms can move pendulously around an axis which is different from that of the lever arm body and they are limited by two dead centers: front dead center E and back dead center F. All three lever arms are installed in such manner that each pendulum oscillation lies on a different plane in order that movement of lever arms does not collide.

Method of creating pendulum oscillation of the pendulum apparatus 2 is similar to that of the aforementioned pendulum apparatus 1.

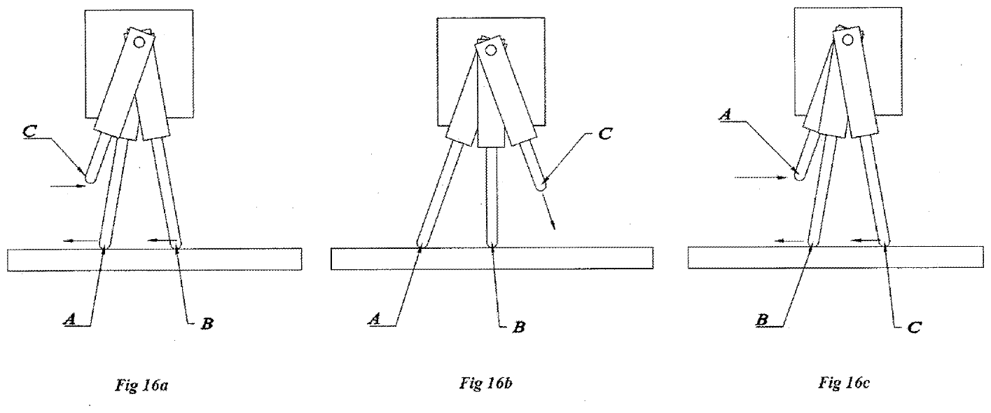

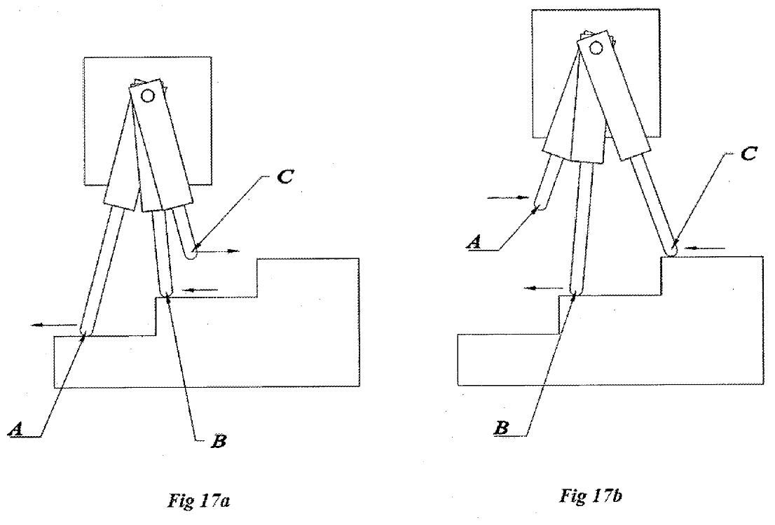

As illustrated in FIGS. 16a, 16b and 16c, operating principle of the pendulum apparatus 2 comprises three phases. In the first phase, lever arms A and B are lengthened and lean on terrain 9 and move from front dead center E to back dead center F, lever arm C is shortened and move with no-load from back dead center F to front dead center E; at this point the apparatus moves based on two bearing points on lever arms A and B. In the second phase, lever arm C reaches the front dead center and it is lengthened to reach the terrain and create new bearing point for the movement, simultaneously lever A reaches back dead center and is shortened and move with no-load to the front dead center. At this point the apparatus moves based on two bearing points of lever arms B and C. Similarly in the third phase, the apparatus moves based on two bearing points of lever arms C and A. Such in-succession operation of the three lever arms creates movement of the apparatus. Meanwhile, longitudinal movement of each lever arms still complies with predefined principles as mentioned in wheel apparatus in order to maintain stability and equilibrium of the frame when moving.

FIGS. 17a, 17b and 17c illustrate operation of pendulum apparatus 2 when climbing stairs.

It is possible to install safety device to avoid stepping into empty space, wherein lever arms are equipped with length sensors, when a lever arm lengthens to the end of its course to reach the terrain but receiving no response (stepping into empty space) the controller stops the apparatus, shortens the lever arms acting as bearing points until the lever arm stepping into empty space receives response, if it does then the apparatus keeps moving forwards.

To prevent the lever arms acting as bearing points from slipping when their speeds on the terrain are different or when the movement direction is changed (take turn), it is possible to equip ends of lever arms with elastic parts (e.g. spring, plastic, etc.).

With the moving apparatus based on lever arms described above, structure and operation of this new apparatus are different from the known apparatuses. The basic difference is the capability of overcoming barricades of the new apparatus, which is based on length change of lever arms combined with rotation or pendulum oscillation of lever arm body creating bearing points for movement of the apparatus. This difference creates better operation of the moving apparatus based on bearing points created by ends of lever arms than other known apparatuses.

I claim:

1. A moving apparatus comprising:
lever arms, wherein each lever arm comprises a body and an end and is configured to change its length based on in-and-out movement of the end of the lever arm along the body of the lever arm to touch the terrain;
a frame;
the lever arms are installed as clusters on the frame, wherein the lever arms of each cluster are arranged equidistantly along the frame and can move on a separate plane in order that clusters of the lever arms do not collide, and the lever arm body can move pendulously around an axis on the frame which is different from that of the lever arm body;
the lever arms in each cluster oscillates simultaneously thanks to the actuation in order to create moving apparatus under the form of pendulum oscillation which can move based on combination of pendulum oscillation of lever arm clusters and changes in length of each lever arm, which creates bearing points of the apparatus on the terrain.

2. The moving apparatus according to claim 1, wherein the lever arms of each cluster oscillates simultaneously thanks to the structure of con rod-crankshaft, one end of the crankshaft rotates around an axis on the apparatus frame and another end connects with con rods which connects with bodies of the lever arms by the remaining end in order that con rods push lever arms of each cluster to oscillates pendulously.

3. The moving apparatus according to claim 1, wherein the lever arms of each cluster oscillates simultaneously thanks to the structure of con rod-camshaft, the camshaft is installed rotatably to the apparatus frame and has exclusive groove with appropriate profile, the con rod has two ends connecting with lever arm bodies of a cluster and it is bolted to the groove in order that when the camshaft rotates, the groove pushes the bolt to move with the con rod to create pendulum oscillation of the cluster of lever arms.

4. The moving apparatus according to claim 1, wherein the in-and-out movement of the end of the lever arm to change lever arm length is created based on steam cylinder structure or hydraulic cylinder structure.

5. The moving apparatus according to claim 1, wherein the in-and-out movement of the end of lever arm to change lever arm length is created based on structure of rack wheel-rack bar.

6. The moving apparatus according to claim 1, wherein the in-and-out movement of the end of lever arm to change lever arm length is created based on worm shaft structure.

7. The moving apparatus according to claim 1, wherein the in-and-out movement of the end of the lever arm to change lever arm length is created based on combination of such controlling methods as spring, rack wheel and rack bar.

8. The moving apparatus according to claim 2, wherein the in-and-out movement of the end of the lever arm to change lever arm length is created based on steam cylinder structure or hydraulic cylinder structure.

9. The moving apparatus according to claim 2, wherein the in-and-out movement of the end of the lever arm to change lever arm length is created based on structure of rack wheel-rack bar.

10. The moving apparatus according to claim 2, wherein the in-and-out movement of the end of the lever arm to change lever arm length is created based on worm shaft structure.

11. The moving apparatus according to claim 2, wherein the in-and-out movement of the end of the lever arm to change lever arm length is created based on combination of such controlling methods as spring, rack wheel and rack bar.

12. The moving apparatus according to claim 3, wherein the in-and-out movement of the end of the lever arm to change lever arm length is created based on steam cylinder structure or hydraulic cylinder structure.

13. The moving apparatus according to claim 3, wherein the in-and-out movement of the end of the lever arm to change lever arm length is created based on structure of rack wheel-rack bar.

14. The moving apparatus according to claim 3, wherein the in-and-out movement of the end of the lever arm to change lever arm length is created based on worm shaft structure.

15. The moving apparatus according to claim 3, wherein the in-and-out movement of the end of the lever arm to change lever arm length is created based on combination of such controlling methods as spring, rack wheel and rack bar.
